(19) United States
(12) Patent Application Publication
(10) Pub. No.: US 2004/0175562 A1
(43) Pub. Date: Sep. 9, 2004

(54) Laminate and light-reflecting sheet

(76) Inventors: Masahiko Hayashi, Kanagawa-ken (JP); Kyoichi Kubomura, Kanagawa-ken (JP); Hiroya Nishioka, Kanagawa-ken (JP)

Correspondence Address: BIRCH STEWART KOLASCH & BIRCH, PO BOX 747, FALLS CHURCH, VA, 22040-0747, US

(21) Appl. No.: 10/482,051

(22) PCT Filed: Jun. 21, 2002
(86) PCT No.: PCT/JP02/06224

(30) Foreign Application Priority Data
Jun. 27, 2001 (JP) 2001-194315

(51) Int. Cl. B32B 5/16

(52) U.S. Cl. 428/330; 428/327

(57) ABSTRACT

A light reflection sheet (1) composed of a laminate comprising a white pigment contained layer 8 having projections having an average height of 0.1 to 5 μm on the layer surface and a polymer layer 9 stacked on the projection 7 side surface of the white pigment contained layer 8 is provided. According to the present invention, it is possible to provide a light reflection sheet composed of a laminate, having no luminance unevenness, being hard to cause a white spot phenomenon and not causing Moire fringes due to sticking.

### TECHNICAL FIELD

The present invention relates to a laminate, a light reflection sheet composed of the laminate, a backlight unit provided with the light reflection sheet and a liquid crystal display device provided with the backlight unit.

### BACKGROUND ART

A liquid crystal display device used as a display of a computer and television, etc. comprises at least a backlight unit and a liquid crystal display panel. The backlight unit comprises at least a light source, a light guide plate and a light reflection sheet. The backlight unit is configured, for example, to make a light from the light source enter to a side end surface of the approximate plate shaped light guide plate, emit from a light emission surface of the light guide plate to be a front face of the display (and after making the light diffused by a diffusion sheet and converged by a prism sheet in accordance with need), and illuminate a back surface of the liquid crystal display panel.

The light from the light source entered to the light guide plate is reflected inside the light guide plate, a part thereof is emitted to the light emission surface and other part is emitted from the back surface of the light guide plate on the opposite side from the light emission surface. The light emitted from the back surface of the light guide plate is reflected by the light reflection sheet arranged on the back surface side and returned to inside the light guide plate.

As the light reflection sheet, a sheet being formed a white pigment contained layer obtained by applying a paint including white pigment or mixing white pigment, a sheet obtained by applying a fine foamed hollow portion or a hollow resin powder (The Japanese Unexamined Patent Publication No. 9-63329) and a white foamed polyester sheet applied with white ink on its back surface, etc. have been proposed.

In recent years, a liquid crystal display device has been demanded to be wide and thin. Thus, a backlight unit to illuminate the liquid crystal display panel is required to be thin.

However, when the backlight unit is made thin, a light from a side end surface of the light guide plate becomes hard to reach the whole surface of the light guide plate and luminance unevenness is easily caused. Also, a part of display of the liquid crystal display device looks white (a white spot phenomenon) in some cases. Furthermore, since a thin backlight unit easily warps, a frame or a member for holding the backlight unit, etc. contacts the back surface of the back light unit, so that the surface of the light guide plate, etc. is damaged and the light reflection sheet is sticked to the light guide plate in some cases. As a result that the light guide plate and the light reflection sheet are partially sticked and a space between the light guide plate and the light reflection sheet becomes uneven, Moire fringes like the Newton ring arises in some cases.

### DISCLOSURE OF THE INVENTION

An object of the present invention is to provide a laminate suitably used for a light reflection sheet, which has no luminance unevenness, hardly causes a white spot phenomenon and does not bring Moire fringes due to sticking, a light reflection sheet composed of the laminate, a backlight unit provided with the light reflection sheet and a liquid crystal display device.

The present inventors found that luminance unevenness is prevented and the white spot phenomenon hardly arises even in a thin back light unit by using a light reflection sheet composed of a laminate applied with the configuration below and accomplished the present invention based on the knowledge.

Namely, according to a first aspect of the present invention, there is provided a laminate, comprising:

a white pigment contained layer having projections having an average height of 0.1 to 5 μm on a surface of the layer; and

a polymer layer laminated on said projection side surface of the white pigment contained layer.

Also, according to a second aspect of the present invention, there is provided a laminate, comprising:

a white pigment contained layer; and

a polymer particle contained layer laminated on a surface of the white pigment contained layer.

Also, according to a third aspect of the present invention, there is provided a laminate, configured by laminating a white pigment contained layer and a polymer layer having projections having an average height of 0.1 to 40 μm on a surface of the polymer layer.

Preferably, the laminate according to the third aspect is obtained by covering a projection side surface of the white pigment contained layer having the projections on the layer surface with a polymer layer.

Preferably, a laminate according to the third aspect is obtained by covering the white pigment contained layer with a polymer particle contained layer.

The respective laminates can be used for a light reflection sheet, a diffusion sheet and a prism sheet, etc. Among these, it can be preferably used for a light reflection sheet.

Namely, according to the present invention, there is provided a light reflection sheet composed of any one of the above laminates.

According to those inventions, a laminate which has no luminance unevenness, hard to cause the white spot phenomenon and does not cause Moire fringes due to sticking, etc. and a light reflection sheet composed of the laminate can be provided.

Also, according to the present invention, there is provided a backlight unit, comprising at least a light source, a light reflection sheet and a light guide plate, wherein:

said light reflection sheet is composed of a light reflection sheet as set forth in claim 13; and

said light reflection sheet is superimposed on said light guide plate, so that a polymer layer or a polymer particle contained layer of a laminate composing said light reflection sheet is arranged on said light guide plate side.

Preferably, in the backlight unit of the present invention, said light guide plate is composed of hydride of ring-opening polymer of norbornene-based monomer.

In the backlight unit of the present invention, normally, a light diffusion sheet is superimposed on the front surface of the light guide plate, a light convergence sheet (for example, a prism sheet is used) is superimposed on the front face of the light diffusion sheet.

Also, according to the present invention, there is provided a liquid crystal display device, comprising at least a backlight unit and a liquid crystal display panel, wherein the backlight unit is arranged so as to illuminate the liquid crystal display panel; and

said backlight unit is composed of the above backlight unit.

According to these inventions, since the light reflection sheets explained above are used, a backlight unit and a liquid crystal display device which has no luminance unevenness, hard to cause the white spot phenomenon and does not cause Moire fringes due to sticking, etc. can be provided. The liquid crystal display device is preferable as a display device of electronic equipments, such as a notebook type personal computer and a wall-hang TV, demanded to be wide and thin.

In the present invention, said polymer layer is preferably composed of at least one polymer selected from polyurethane, polyester urethane, polyester and cyclized rubber.

In the present invention, preferably, said polymer particle is composed of a polyurethane particle or a silicon rubber particle.

In the present invention, preferably, an average particle diameter of said polymer particle is 1 to 60 μm.

In the present invention, preferably, white pigment contained in said white pigment contained layer is composed of calcium carbonate.

In the present invention, preferably, a hollow portion exists in said white pigment contained layer.

In the present invention, preferably, an average diameter of fine foam forming said hollow portion is 50 μm or less.

In the present invention, preferably, an average thickness of said polymer layer or polymer particle contained layer is 0.1 to 20 μm.

### BRIEF DESCRIPTION OF DRAWINGS

FIG. 1 is a sectional view of a laminate according to an embodiment of the present invention.

FIG. 2 is a sectional view of a liquid crystal display device according to an embodiment of the present invention.

FIGS. 3 and 4 are sectional views of a laminate according to other embodiments of the present invention.

### BEST MODE FOR CARRYING OUT THE INVENTION

The case where a laminate according to the present invention is used for a light reflection sheet incorporated in a backlight of a liquid crystal display device will be explained as an example below.

As shown in FIG. 2, a liquid crystal display device 100 according to the present embodiment comprises a backlight unit 11 and a liquid crystal display panel 5, and the backlight unit 11 is arranged so as to illuminate the liquid crystal display panel 5.

The liquid crystal display panel 5 comprises a liquid crystal cell and a polarizing plate. The liquid crystal cell is what obtained by sandwiching a liquid crystal layer (there are TN type liquid crystal, STN type liquid crystal, IPS liquid crystal and VA liquid crystal, etc.) with transparent substrates, such as glass substrates and resin substrates. An ITO (indium, oxide tin) film or other conductive film is stacked on the transparent substrate. There are at least two polarizing plates so as to hold outside of the transparent substrates.

In the liquid crystal display panel 5, a part of the liquid crystal layer of the liquid crystal cell is applied with an electric field via a conductive film on the transparent substrate and a light transmission state is modulated on the part so as to control a relationship of a light transmission axis of the polarizing plate for sandwiching the substrate and the polarizing direction of a light passed through the liquid crystal layer. Then, a light amount passing through the liquid crystal cell is changed and information of a letter and pattern, etc. is displayed.

The backlight unit 11 comprises a light source 6, a light reflection sheet 1, a light guide plate 2, a light diffusion sheet 3 and a light convergence sheet 4 in the present embodiment.

The light source 6 is arranged at a side portion of the light guide plate 2. As the light source 6, a fluorescent lamp composed of a cold-cathode tube and light-emitting diode are normally used. A reflection plate (not shown) is arranged around the light source 6, so that the light from the light source 6 is converged to emit on the side end surface of the light guide plate 2. Here, the reflection plate is not particularly limited as far as it can regularly reflect or irregularly reflect the light from the light source 6.

The light guide plate 2 has an approximate plate shape (having a wedge shaped section, etc.) in the present embodiment and being capable of receiving a light from the side end surface, and the incident light reflects inside the light guide plate 2 and is emitted from the front face of the light guide plate 2. To make the light reflect in the light guide plate 2 and is emitted from the front face of the light guide plate 2, it is sufficient if, for example, particles for scattering the light are dispersed in the light guide plate 2, dots and lines are provided by printing on the back surface of the light guide plate 2, or convex portions or concave portions of dots and lines are formed, etc. Among those, it is preferable to form concave portions of dots and lines on the back surface of the light guide plate 2. By forming concave portions on the back surface of the light guide plate 2, the white spot phenomenon can be suppressed.

The light guide plate 2 is formed by a transparent resin for attaining a light weight. As the transparent resin forming the light guide plate, a polycarbonate resin; an acrylic resin; a ring-opening polymer of a norbornene-based monomer, such as tetracyclododecene, dicyclopentadiene, and hydrides of these; an addition copolymer of a norbornene-based monomer and ethylene; an addition polymer of a norbornene-based monomer; an aromatic ring hydride of a stylene-based polymer, such as polystyrene and styrene - conjugated diene block copolymer; etc. may be mentioned. Among these, a hydride of a ring-opening polymer of a norbornene-based monomer is preferable because a backlight unit 11 having high luminance can be obtained thereby.

The light diffusion sheet 3 is superimposed on the front surface of the light guide plate 2. The light diffusion sheet 3 is obtained by dispersing transparent particles capable of scattering a light. As the transparent resin, the same resin for forming the light guide plate 2 is used. As the transparent particle, silicon resin particle, polystyrene particle, acrylic resin particle and glass particle, etc. may be mentioned.

The light convergence sheet 4 is superimposed on the front face of the light diffusion sheet 3. The light convergence sheet 4 is made by a transparent resin and normally prismatic recesses and projections are formed on the surface. The light scattered by the light diffusion sheet 3 is converged by the prismatic recesses and projections so as to illuminate the liquid crystal display panel 5. A repetition pitch of the prism is normally 30 μm or so. An angle at the top of the prism is normally 30 to 70 degrees. A section shape of this top portion may be symmetric or asymmetric in accordance with a required characteristic. Also, the direction that the light is converged is determined in accordance with the prism shape in the light convergence sheet 4. Therefore, it is preferable that two or more light convergence sheets 4 are superimposed to be used to secure different light converging directions. By doing so, the light converging direction can be made uniform. Furthermore, a protective film can be superimposed on the front face side of the light convergence sheet 4.

First Aspect

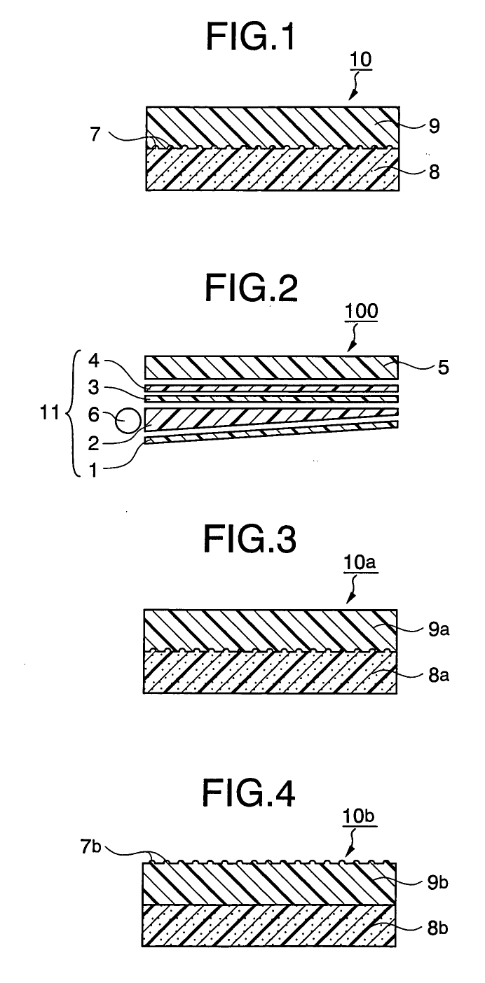

The light reflection sheet 1 can be, for example, configured by a laminate 10 according to an embodiment of the first aspect of the present invention as shown in FIG. 1.

The laminate 10 of the first aspect comprises a white pigment contained layer 8 having projections 7 on its layer surface and a polymer layer 9 stacked on the surface of the projection 7 side of the white pigment contained layer 8.

The white pigment contained layer 8 is not particularly limited as far as it contains white pigment, but normally white pigment is dispersed in matrix of a resin, etc.

As the white pigment, for example, zinc, zinc oxide, rutile type titanium oxide, anatase type titanium oxide, barium sulfate, calcium sulfate, basic lead sulfate, lithopone, zinc sulfate, lead titanate, zirconium oxide, barite, barium carbonate, chalk, precipitated calcium carbonate, gypsum, magnesium carbonate, alumina, clay, talcum powder, and diatom earth, etc. may be mentioned. Among these, calcium carbonate is preferable. An average particle diameter of white pigment is normally 0.1 to 5 μm, preferably 0.5 to 3 μm.

As a resin to compose a matrix, an ABS resin, a polyester resin, a polycarbonate resin, a polyamide resin, polystyrene, polyethylene, polypropylene, poly(metha)acrylate, polyether sulfone, a urethane resin, an epoxy resin, polyimide, etc. may be mentioned. Among these, a polyester resin, particularly polyethylene terephthalate are preferable.

An amount of white pigment with respect to 100 parts by weight is normally 200 to 2000 parts by weight, preferably 250 to 1500 parts by weight. When the pigment is too less, it becomes difficult to uniformly reflect a light, while when too much, the white pigment starts to absorb the light and the reflectance declines.

The matrix made by a resin is preferably formed fine foams therein, so that the light reflectance can be heightened, the backlight unit can be made lighter, and strength against heat and impact can be improved.

As a method of forming fine foams in the resin matrix, a method of making hollow particles contained and other well-known foaming method can be applied. As the foaming method, there are, for example, a method of making a blowing agent contained in a resin to generate a gas at the time of forming a white pigment contained layer and a method of strongly mixing resin emulsion blended with white pigment to mixing in an air, etc.

An average diameter of the fine foam is preferably 50 μm or less, more preferably 30 μm or less, and particularly preferably 20 μm or less. When the foam becomes too large, the light reflectance declines.

An average thickness of the white pigment contained layer 8 is normally 5 to 300 μm, preferably 20 to 100 μm.

The white pigment contained layer 8 is not particularly limited by the forming method. As the forming method of the white pigment contained layer, for example, a method of performing melt molding on a resin containing white pigment to be a film may be applied, but a method of applying a paint containing white pigment to a base member is more preferable for being excellent in workability of forming a hallow portion, etc.

A resin (=matrix) contained in the paint used for forming the white pigment contained layer 8 by the application method may be any of an emulsion type, dispersion type and solution type. Also, the application method is not particularly limited and, for example, a roll coater application, spray application, brush paint application, screen printing method, etc. may be mentioned.

The base member used in the application method is normally a resin sheet. As the resin sheet, an ABS resin sheet, a polyester resin sheet, a polycarbonate resin sheet, a polyamide resin sheet, a poly(metha)acrylate sheet and a polyether sulfone sheet, etc. may be mentioned. Among these, a polyester resin sheet, particularly polyethylene terephthalate sheet are preferable. An average thickness of the sheet as the base member is normally 5 μm or more, preferably 10 to 100 μm.

On the back surface of the base member (namely, the back surface of a surface on which the white pigment contained layer 8 is formed) is preferably provided with a regular reflection layer, such as a silver mirror, or a white ink layer. A light leaked through the base member can be reflected by the regular reflection layer or white ink layer and returned to the front face of the base member. Also, by providing a silver mirror or other regular reflection layer on the front face of the base member (namely, the surface on which the white pigment contained layer 8 is formed), the reflection efficiency of the light can be improved.

An average height of projections 7 on the surface of the white pigment contained layer 8 is preferably 0.1 to 5 μm, more preferably 0.5 to 3 μm, particularly preferably 0.7 to 2.5 μm. A shape of the projection 7 is not particularly limited, but is normally an approximate conical shape having a round top. Due to provision of the projections 7, the light reflection sheet becomes hard to be sticked to the light guide plate and a later explained polymer layer becomes easy to adhere to the white pigment contained layer 8. The number of the projections 7 is not particularly limited and they are randomly arranged on the surface of the white pigment contained layer 8. The projections 7 on the surface of the white pigment contained layer 8 are formed as a result that the white pigment protrudes from the surface and the surface is mounded by the white pigment.

The polymer layer 9 laminated on the surface on the projection 7 side of the white pigment contained layer 8 is a layer made by a polymer. The polymer layer 9 is preferably transparent in terms of heightening the reflecting efficiency and a color of the reflection light.

The polymer used for the polymer layer 9 is not particularly limited. For example, polyurethane; polyolefin, polyester urethane; polyester; acrylonitrile-butadiene rubber, styrene-butadiene rubber and other butadiene based rubber; styrene-butadiene-styrene block copolymer, styrene-isoprene-styrene block copolymer and hydrides of these and other thermoplastic elastomer; cyclized rubber; natural rubber; silicon rubber, etc. may be mentioned. Among these, polyurethane, polyester urethane, polyester and cyclized rubber are preferable for having excellent adhesiveness to the white pigment contained layer 8.

Second Aspect

The light reflection sheet shown in FIG. 2 may be also configured by a laminate 10a according to an embodiment according to the second aspect of the present invention, for example, as shown in FIG. 3.

The laminate 10a of the second aspect comprises a white pigment contained layer 8a and a polymer particle contained layer 9a laminated on the surface of the white pigment contained layer 8a.

The white pigment contained layer 8a can be configured in the same way as the white pigment contained layer 8 of the laminate 10 shown in FIG. 1.

The polymer particle contained layer 9a is not particularly limited as far as it contains polymer particle, but is normally a layer wherein polymer particle is dispersed in a matrix of a resin or elastomer, etc.

As the polymer constituting the polymer particle, the same ones mentioned as a polymer to constitute the polymer layer 9 of the laminate 10 may be mentioned. Those preferable as the polymer particle are polyurethane particle and silicon rubber particle. An average particle diameter of the polymer particle is preferably 1 to 60 μm, more preferably 5 to 30 μm. The polymer particle is preferably transparent for heightening the light reflection efficiency of the light reflection sheet.

The polymer layer 9 of the laminate 10 shown in FIG. 1 or the polymer particle contained layer 9a of the laminate 10a shown in FIG. 3 may cover the whole surface of the white pigment contained layers 8 and 8a or cover partially like a dot pattern, etc.

A method of forming the polymer layer 9 of the laminate 10 shown in FIG. 1 and the polymer particle contained layer 9a of the laminate 10a shown in FIG. 3 is not particularly limited. But preferably, a method of activating the surface of the white pigment contained layer 8 or 8a in accordance with need by irradiating an ultraviolet ray on the surface of the white pigment contained layer 8 or 8a or making it contact plasma and, then, applying a paint made by a polymer or a paint containing polymer particle may be mentioned. Note that the paint made by a polymer is obtained by dissolving or dispersing a polymer in a solvent. The application method is the same as the application method for forming the white pigment contained layer 8 and 8a.

An average thickness of the polymer layer 9 of the laminate 10 shown in FIG. 1 or the polymer particle contained layer 9a of the laminate 10a shown in FIG. 3 is preferably 0.1 to 20 μm, more preferably 1 to 10 μm.

Third Aspect

The light reflection sheet 1 shown in FIG. 2 can be composed of a laminate 10b according to an embodiment of the third aspect of the present invention, for example, as shown in FIG. 4.

The laminate 10b of the third aspect is made by laminating a white pigment contained layer 8b and a polymer layer 9b and the surface of the polymer layer 9b has projections 7b having an average height of 0.1 to 40 μm. The projections 7b are made by a polymer. Such a laminate 10b is obtained by covering surfaces of the projections 7 of the white pigment contained layer 8 having the projections 7 shown in FIG. 1 with the polymer layer 9 shown in FIG. 1. Also, the laminate 10b can be obtained also by covering the white pigment contained layer 8a shown in FIG. 3 with the polymer particle contained layer 9a . An average height of the projections 7b made by a polymer is preferably 0.1 to 40 μm, more preferably 0.5 to 30 μm. A shape of the projections 7b is not particularly limited, but they are randomly arranged on the surface of the polymer layer 9b.

In the present embodiment, the light reflection sheet 1 is superimposed on the light guide plate 2 so that the polymer layer 9 of the laminate 10 shown in FIG. 1, the polymer particle contained layer 9a of the laminate 10b shown in FIG. 3 or the projections 7b made by a polymer of the laminate 10b shown in FIG. 4 are arranged on the light guide plate 2 side shown in FIG. 2.

In the present embodiment, the light reflection sheet 1 is composed of the laminates 10, 10a and 10b of the present invention. Therefore, by illuminating the liquid crystal display panel 5 by a backlight unit 11 provided with such a light reflection sheet, a liquid crystal display device 100 having no luminance unevenness and hardly causing the white spot phenomenon can be obtained.

As explained above, an explanation was made on the embodiments of the present invention, but the present invention is not limited to these embodiments and may naturally be modified in various ways within the scope of the present invention.

In the above embodiments, the case of using a laminate according to the present invention as a light reflection sheet incorporated in a backlight of a liquid crystal display device was described as an example, but use of the laminate of the present invention is not limited to this and may be used, for example, for a diffusion sheet and prism sheet, etc.

### EXAMPLES

Below, the present invention will be explained in detail by giving examples and comparative examples. Note that “part” means “part by weight” unless otherwise mentioned.

Evaluation Method

Evaluation methods taken in the present examples are as below.

Luminance Distribution

Twenty five points on a light emission surface of a backlight were evenly selected and luminance on the points was measured by using CA1000 (made by Minolta Co. Ltd.). As a uniformity evaluation of luminance within the surface, the rate of the minimum luminance value to the maximum luminance value in the 25 measurement values was calculated and the value was used as an evaluation of the luminance unevenness. When the evaluation value was 0.75 or more, it was evaluated as “◯”, and when less than 0.75, it was evaluated as “X”.

Push Test

The center of the back surface of the liquid crystal display device was pressed by a load of 10 kgf repeatedly for 15000 times. After that, the liquid crystal display device was brought into operation and an existence of a white spot was visually observed. Furthermore, a light guide plate was removed from the liquid crystal display device and the pressed part of the light guide plate was observed with an optical microscope. The case where there was no scratch was evaluated as “⊚”, the case where the light guide plate has a slight scratch but a white spot was not observed was evaluated as “◯”, the case where a white spot was faintly observed was evaluated as “Δ”, and the case where a white spot was clearly observed was evaluated as “X”.

Friction Coefficient

A polymer layer or a polymer particle contained layer of a light reflection sheet was brought to contact a flat plate formed by a resin composing a light guide plate, a load of 1 kgf was imposed perpendicular to the flat plate from the light reflection sheet side, and the light reflection sheet was drawn in the direction in parallel with the flat plate at a speed of 30 mm/min. to obtain a static friction coefficient. When the friction coefficient was 0.4 or less, it was evaluated “◯”, and when more than 0.4, it was evaluated as “X”. When the static friction coefficient is large, the light guide plate is sticked to the light reflection sheet, and Moire fringes like the Newton ring arises in some cases.

### Example 1

A ultrafine foamed sheet made by polyethylene terephthalate containing calcium carbonate, having a thickness of 188 μm, a length of 291 mm and a width of 218 mm, wherein an average foam diameter is 20 μm or less and a large number of projections of about 1.5 μm are provided on its surface was prepared as a white pigment contained layer. Next, after irradiating an ultraviolet ray on the surface of the white pigment contained layer, a clear paint made by polyurethane was applied on the whole surface on the projection 7 side of the white pigment contained layer to be a thickness of 8 μm by screen printing and dried to obtain a laminate. Namely, in the present example, the polymer layer was a polyurethane layer. On the surface of the polyurethane layer, projections of about 0.7 μm were formed. In the present example, the laminate was used as a light reflection sheet.

A ring-opening polymer of tetracyclo[4.4.0.1^{2,5}.1^{7,10}]-3-dodecene is hydrogenated at hydrogenation rate of 99% and a hydrogenation product of a ring-opening polymer having a number-average molecular weight of about 27500 was obtained. A mold provided with a stamper for forming line shaped convex portions on the back surface is used for injection-molding the hydrogenation product of a ring-opening polymer, and a flat plate wherein the thickness gradually decreases like a wedge shape (a length 291 mm, width 218 mm, thickness 2.1 mm at maximum and 0.7 mm at minimum) was formed, so that a light guide plate was obtained.

On the back surface of the light guide plate, the light reflection sheet was superimposed so that the polyurethane layer comes to the light guide plate side. On the front surface of the light guide plate, a light diffusion sheet wherein acryl resin beads are dispersed and two light convergence sheets formed with a prism pattern (one prism direction becomes the vertical direction and the other prism direction becomes the transversal direction) are successively superimposed and they were fit in a frame provided with a cold-cathode tube, so that a backlight unit was obtained. A luminance distribution of the backlight unit was measured.

When the cold-cathode tube is turned on, a beam enters the side end surface of the light guide plate, scatters on the line convex portions on the back surface of the light guide plate and is irradiated on the front face of the light guide plate. A light leaked from the back surface of the light guide plate is reflected on the light reflection sheet and returned to the light guide plate. The light emitted from the front face of the light guide plate passes through the light diffusion sheet and the light convergence sheet and is emitted from the front surface of the backlight unit.

The backlight unit is attached on the back surface of the liquid crystal display panel and fit in a frame of a notebook type personal computer, so that a liquid crystal display device was obtained. The push test was conducted on the liquid crystal display device. The evaluation results are shown in Table 1.

### Example 2

A light reflection sheet was obtained in the same way as in the example 1 except for performing spray application up to a film thickness of 3 μm instead of performing screen printing up to a film thickness of 8 μm. Namely, the polymer layer was also a polyurethane layer in the present example. Projections of about 0.7 μm were formed on the surface of the polyurethane layer. Also, the light reflection sheet was used to obtain a backlight unit and a liquid crystal display device in the same way as in the example 1. The evaluation results are shown in Table 1.

### Example 3

A light reflection sheet was obtained in the same way as in the example 1 except for using a clear paint made by polyester instead of a clear paint made by polyurethane. Namely, in the present example, the polymer layer was a polyester layer. Projections of about 0.7 μm were formed on the polyester layer. Also, the light reflection sheet was used to obtain a backlight unit and a liquid crystal display device in the same way as in the example 1. The evaluation results are shown in Table 1.

### Example 4

A light reflection sheet was obtained in the same way as in the example 2 except for using a clear paint made by polyurethane wherein silicon rubber particle having an average particle diameter of 12 μm was dispersed by 1% instead of a clear paint made by polyurethane. Namely, in the present example, the polymer particle contained layer was a polyurethane layer including silicon rubber particle. Projections of about 4 μm were formed on the polyurethane layer. Also, the light reflection sheet was used to obtain a backlight unit and a liquid crystal display device in the same way as in the example 1. The evaluation results are shown in Table 1.

Example 5

A light reflection sheet was obtained in the same way as in the example 1 except for using a clear paint made by cyclized rubber instead of a clear paint made by polyurethane and not performing ultraviolet ray irradiation. Namely, in the present example, the polymer layer was a cyclized rubber layer. Projections of about 0.7 μm were formed on the cyclized rubber layer. Also, the light reflection sheet was used to obtain a backlight unit and a liquid crystal display device in the same way as in the example 1. The evaluation results are shown in Table 1.

### Comparative Example

A light reflection sheet was obtained in the same way as in the example 5 except for not applying a cyclized rubber paint. Namely, in the present comparative example, the polymer layer was not formed. Also, the light reflection sheet was used to obtain a backlight unit and a liquid crystal display device in the same way as in the example 1. The evaluation results are shown in Table 1.

TABLE 1

| | | | Static |
|---|---|---|---|
| | Luminance | Push | Friction |
| | Distribution | Test | Coefficient |
| Example 1 | ∘ | ⊚ | ∘ |
| Example 2 | ∘ | ⊚ | ∘ |
| Example 3 | ∘ | ⊚ | ∘ |
| Example 4 | ∘ | ⊚ | ∘ |
| Example 5 | ∘ | ⊚ | ∘ |
| Comparative | ∘ | X | ∘ |
| Example | | | |

As shown in Table 1, evaluation on the luminance distribution and static friction coefficient was excellent in all of the examples 1 to 5 and comparative example. However, in the push test, a white spot was clearly observed in the comparative example, while such a disadvantage was not caused in the examples 1 to 5, and not to mention the white spot, not a scratch was made on the light guide plate.

1. A laminate, comprising:
a white pigment contained layer having projections having an average height of 0.1 to 5 μm on a surface of the layer; and
a polymer layer laminated on said projection side surface of the white pigment contained layer.

2. A laminate, comprising:
a white pigment contained layer; and
a polymer particle contained layer laminated on a surface of the white pigment contained layer.

3. A laminate, configured by laminating a white pigment contained layer and a polymer layer having projections having an average height of 0.1 to 40 μm on a surface of the polymer layer.

4. The laminate as set forth in claim 3, obtained by covering a projection side surface of the white pigment contained layer having the projections on the layer surface with a polymer layer.

5. The laminate as set forth in claim 3, obtained by covering the white pigment contained layer with a polymer particle contained layer.

6. The laminate as set forth in claim 1 or 4, wherein said polymer layer is composed of at least one polymer selected from polyurethane, polyester urethane, polyester and cyclized rubber.

7. The laminate as set forth in claim 2 or 5, wherein said polymer particle is composed of a polyurethane particle or a silicon rubber particle.

8. The laminate as set forth in claim 2 or 5, wherein an average particle diameter of said polymer particle is 1 to 60 μm.

9. The laminate as set forth in any one of claims 1 to 3, wherein white pigment contained in said white pigment contained layer is composed of calcium carbonate.

10. The laminate as set forth in any one of claims 1 to 3, wherein a hollow portion exists in said white pigment contained layer.

11. The laminate as set forth in claim 10, wherein an average diameter of fine foam forming said hollow portion is 50 μm or less.

12. The laminate as set forth in any one of claims 1 to 3, wherein an average thickness of said polymer layer or polymer particle contained layer is 0.1 to 20 μm.

13. A light reflection sheet composed of a laminate as set forth in any one of claims 1 to 3.

14. A backlight unit, comprising at least a light source, a light reflection sheet and a light guide plate, wherein:
said light reflection sheet is composed of a light reflection sheet as set forth in claim 13; and
said light reflection sheet is superimposed on said light guide plate, so that a polymer layer or a polymer particle contained layer of a laminate composing said light reflection sheet is arranged on said light guide plate side.

15. The back light unit as set forth in claim 14, wherein said light guide plate is composed of hydride of ring-opening polymer of norbornene-based monomer.

16. A liquid crystal display device, comprising at least a backlight unit and a liquid crystal display panel, wherein the backlight unit is arranged so as to illuminate the liquid crystal display panel; and
said backlight unit is composed of the backlight unit as set forth in claim 14.
